(19) United States
(12) Patent Application Publication
(10) Pub. No.: US 2026/0213245 A1
(43) Pub. Date: Jul. 23, 2026

(54) METHOD FOR FORMING ALL-SOLID-STATE BATTERY

(71) Applicant: HONDA MOTOR CO., LTD., Tokyo (JP)

(72) Inventors: Masaki YAMATO, Saitama (JP); Yoshiki MUROYA, Saitama (JP); Koki KANNO, Saitama (JP); Tatsuya HASHIMOTO, Saitama (JP)

(21) Appl. No.: 19/444,194

(22) Filed: Jan. 9, 2026

(30) Foreign Application Priority Data
Jan. 22, 2025 (JP) 2025-009143

(51) Int. Cl. H01M 10/04; H01M 10/0562

(52) U.S. Cl. CPC H01M 10/0404; H01M 10/0562; H01M 2300/0068

(57) ABSTRACT

A method for forming an all-solid-state battery according to an embodiment of the present invention is a method for forming an all-solid-state battery including an electrode stack in which a positive electrode layer, a negative electrode layer, and a solid electrolyte layer disposed between the positive electrode layer and the negative electrode layer are stacked. The method includes a temperature raising step of raising a temperature of the all-solid-state battery; and an aging step of holding the all-solid-state battery in which the temperature has been raised. A method of raising the temperature of the all-solid-state battery in the temperature raising step is a method of dielectrically heating the solid electrolyte layer by applying a high-frequency AC electric field along a stacking direction of the electrode stack.

This application is based on and claims the benefit of priority from Japanese Patent Application No. 2025-009143, filed on 22 Jan. 2025, the content of which is incorporated herein by reference.

### BACKGROUND OF THE INVENTION

### Field of the Invention

The present invention relates to a method for forming an all-solid-state battery.

### Related Art

In recent years, research and development has been conducted on secondary batteries that contribute to energy efficiency in order to ensure that more people have access to affordable, reliable, sustainable, and advanced energy. Among secondary batteries, all-solid-state batteries each formed by stacking a plurality of electrode stacks each formed by stacking a positive electrode, a solid electrolyte, and a negative electrode are considered to be promising.

The manufacturing process of a secondary battery includes a formation step of performing an initial charge and discharge step and an aging step. The initial charge and discharge step is a step of charging and discharging the assembled secondary battery. The aging step is a step in which the secondary battery in a charged state is held in a state in which the temperature thereof is raised to room temperature or higher, and the presence or absence of subsequent deterioration is confirmed. In the aging step, the temperature of the secondary battery may be raised to 60° C. and held. As a method of raising the temperature of the secondary battery, there are known a method of allowing the secondary battery to stand in a heating container such as a thermostatic chamber (temperature controlled thermostatic chamber), and an external heating method of heating the secondary battery from the outside using a heating means such as an infrared heater (see Patent Document 1).
Patent Document 1: Japanese Unexamined Patent Application, Publication No. 2017-22067

### SUMMARY OF THE INVENTION

Incidentally, one of the issues in the technology related to all-solid-state batteries is improving productivity. In order to improve the productivity of the all-solid-state battery, it is effective to shorten the formation time of the assembled all-solid-state battery. In order to shorten the formation time, it is effective to perform the initial charge and discharge step and the aging step in a state in which a plurality of all-solid-state batteries are collectively restrained. However, when the all-solid-state battery before the aging step is heated by an external heating method in a state in which a plurality of all-solid-state batteries are collectively restrained, the time for uniformly raising the temperature inside the all-solid-state battery becomes long. Although it is possible to increase the rate of raising the temperature of the all-solid-state battery by increasing the external temperature, in this case, the temperature of the outer casing of the all-solid-state battery may be excessively raised, and the performance of the all-solid-state battery may be deteriorated.

The present invention has been made in view of the above-described circumstances, and an object of the present invention is to provide a method for forming an all-solid-state battery capable of shortening the time for uniformly raising the temperature of the all-solid-state battery before an aging step without deteriorating the performance of the all-solid-state battery. This contributes to energy efficiency.

The present inventors have found that dielectric heating of a solid electrolyte layer of an all-solid-state battery is effective for the above issue, and have completed the present invention. Accordingly, the present invention provides the following.

A first aspect of the present invention is a method for forming an all-solid-state battery including an electrode stack in which a positive electrode layer, a negative electrode layer, and a solid electrolyte layer disposed between the positive electrode layer and the negative electrode layer are stacked. The method includes a temperature raising step of raising a temperature of the all-solid-state battery by dielectrically heating the solid electrolyte layer by applying a high-frequency AC electric field along a stacking direction of the electrode stack, and an aging step of holding the all-solid-state battery whose temperature has been raised.

According to the method for forming an all-solid-state battery of the first aspect, since the above-described method is used as the method for raising the temperature of the all-solid-state battery in the temperature raising step, the temperature of the all-solid-state battery can be raised from the internal solid electrolyte layer. Therefore, the time for uniformly raising the temperature of the all-solid-state battery can be shortened without deteriorating the performance of the all-solid-state battery. As a result, since the formation time of the all-solid-state battery can be shortened, the productivity of the all-solid-state battery is improved.

In a second aspect of the present invention according to the first aspect, a frequency of the high-frequency AC electric field is in a range of 1 MHz or more and 200 MHz or less.

According to the method for forming an all-solid-state battery of the second aspect, since the frequency of the high-frequency AC electric field is within the above range, the solid electrolyte layer can be more reliably heated.

In a third aspect of the present invention according to the first or second aspect, a frequency of the high-frequency AC electric field is set based on a relative permittivity of the solid electrolyte layer.

According to the method for forming an all-solid-state battery of the third aspect, since the frequency of the high-frequency AC electric field is set based on the relative permittivity of the solid electrolyte layer, the solid electrolyte layer can be even more reliably heated.

In a fourth aspect of the present invention according to any one of the first to third aspects, the temperature raising step is performed while the all-solid-state battery is restrained in the stacking direction of the electrode stack.

According to the method for forming an all-solid-state battery of the fourth aspect, the temperature of the all-solid-state battery can be more uniformly raised.

In a fifth aspect of the present invention according to any one of the first to fourth aspects, the all-solid-state battery includes a laminate film covering the electrode stack. In the temperature raising step, a pair of electrodes are disposed on a surface of the laminate film so as to sandwich the all-solid-state battery in the stacking direction of the electrode stack, and the high-frequency AC electric field is applied between the pair of electrodes.

According to the method for forming an all-solid-state battery of the fifth aspect, even when a plurality of all-solid-state batteries are stacked in the stacking direction of the electrode stack, the temperature of each of the all-solid-state batteries can be uniformly raised.

In a sixth aspect of the present invention according to any one of the first to fourth aspects, the all-solid-state battery includes a laminate film covering the electrode stack. The positive electrode layer includes a positive electrode current collector, and a positive electrode tab connected to the positive electrode current collector is exposed from the laminate film. The negative electrode layer includes a negative electrode current collector, and a negative electrode tab connected to the negative electrode current collector is exposed from the laminate film. In the temperature raising step, the high-frequency AC electric field is applied between the positive electrode tab and the negative electrode tab.

According to the method for forming an all-solid-state battery of the sixth aspect, even when a plurality of all-solid-state batteries are stacked in the stacking direction of the electrode stack, the temperature of each of the all-solid-state batteries can be uniformly raised.

In a seventh aspect of the present invention according to any one of the first to sixth aspects, the solid electrolyte layer includes a sulfide solid electrolyte.

According to the method for forming an all-solid-state battery of the seventh aspect, the solid electrolyte layer can be reliably heated by applying a high-frequency AC electric field.

According to the present invention, it is possible to provide a method for forming an all-solid-state battery capable of shortening the time for uniformly raising the temperature of the all-solid-state battery before an aging step without deteriorating the performance of the all-solid-state battery.

### BRIEF DESCRIPTION OF THE DRAWINGS

FIG. 1 is a perspective view showing an example of an all-solid-state battery that can be used in a method for forming an all-solid-state battery according to the present invention;

FIG. 2 is a cross-sectional view taken along line II-II of FIG. 1;

FIG. 3 is a schematic view showing an example of a dielectric heating system used in a temperature raising step of the method for forming an all-solid-state battery according to the present invention;

FIG. 4 is a schematic view showing another example of the dielectric heating system used in the temperature raising step of the method for forming an all-solid-state battery according to the present invention;

FIG. 5 is a cross-sectional view of an evaluation sample used in a verification experiment of the method for forming an all-solid-state battery according to the present invention; and

FIG. 6 is a schematic diagram showing a dielectric heating system used in the verification experiment of the method for forming an all-solid-state battery according to the present invention.

### DETAILED DESCRIPTION OF THE INVENTION

Hereinafter, a method for forming an all-solid-state battery according to an embodiment of the present invention will be described with reference to the drawings. In the present embodiment, the all-solid-state battery is a lithium metal battery using lithium ions as a charge transfer medium.

The formation of the all-solid-state battery is performed on the all-solid-state battery immediately after assembly. First, the configuration of an all-solid-state battery to be subjected to the formation method of the present embodiment will be described.

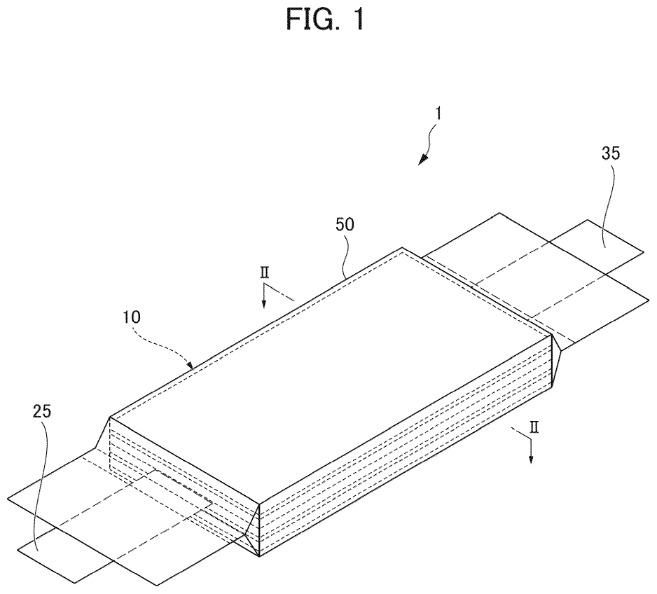

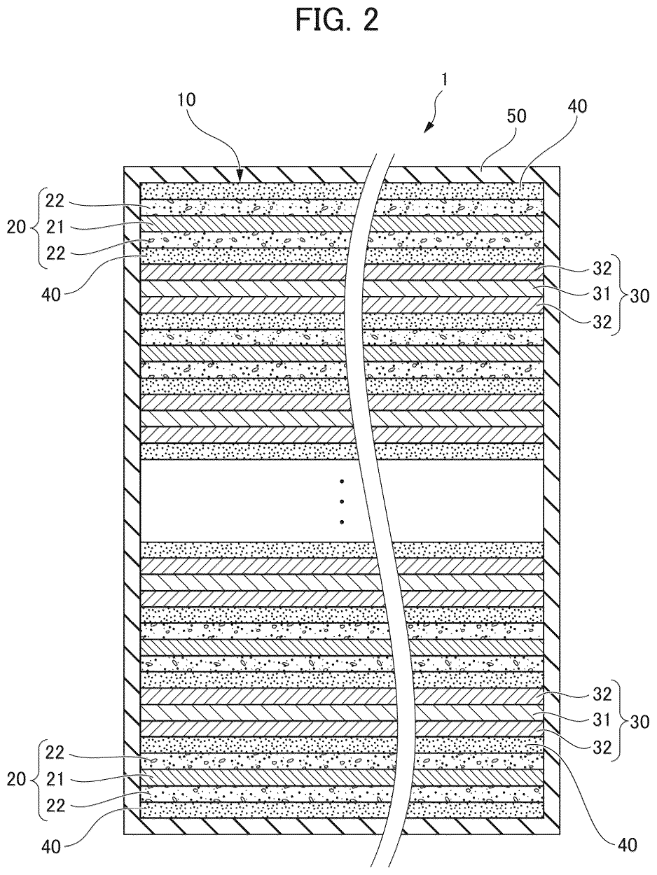

FIG. 1 is a perspective view showing an example of an all-solid-state battery that can be used in the method for forming an all-solid-state battery according to the present invention. FIG. 2 is a cross-sectional view taken along line II-II of FIG. 1.

An all-solid-state battery 1 includes an electrode stack 10 and an outer casing 50 that houses the electrode stack 10. A positive electrode tab 25 and a negative electrode tab 35 extend outward from the outer casing 50.

The electrode stack 10 is a stack in which a positive electrode layer 20, a negative electrode layer 30, and a solid electrolyte layer 40 disposed between the positive electrode layer 20 and the negative electrode layer 30 are stacked. The solid electrolyte layers 40 are disposed at both ends of the electrode stack 10 in the stacking direction. In the electrode stack 10, the solid electrolyte layer 40, the positive electrode layer 20, the solid electrolyte layer 40, the negative electrode layer 30, the solid electrolyte layer 40, the positive electrode layer 20, . . . the positive electrode layer 20, the solid electrolyte layer 40, the negative electrode layer 30, the solid electrolyte layer 40, the positive electrode layer 20, and the solid electrolyte layer 40 are stacked in this order.

The positive electrode layer 20 includes a positive electrode current collector 21 and positive electrode active material layers 22 disposed on both side surfaces of the positive electrode current collector 21.

Examples of the shape of the positive electrode current collector 21 include a foil shape, a plate shape, a mesh shape, a nonwoven fabric shape, and a foamed shape. Examples of the material for the positive electrode current collector 21 include aluminum, an aluminum alloy, stainless steel, nickel, iron, and titanium.

The positive electrode active material layer 22 contains a positive electrode active material. The positive electrode active material may contain a lithium compound that releases lithium ions during charging and absorbs lithium ions during discharging. As the lithium compound, for example, a layered active material, a spinel active material, or an olivine active material can be used. Specific examples of the positive electrode active material include lithium cobaltate (LiCoO₂), lithium nickelate (LiNiO₂), lithium nickel manganese cobalt oxide (NMC: LiNiₚMn_{q}COᵣO_{z} (p+q+r=1)), LiNiₚAl_{q}CoᵣO₂ (p+q+r=1), lithium manganate (LiMn₂O₄), heterogenous element-substituted Li—Mn spinel represented by Li₁₊ₓMn_{2-x-y}M_{y}O₄ (x+y=2; M is at least one selected from Al, Mg, Co, Fe, Ni, or Zn), lithium titanate (an oxide containing Li and Ti), and lithium metal phosphate (LiMPO₄; M is at least one selected from Fe, Mn, Co, or Ni). The positive electrode active material layer 22 may further contain a conductivity aid, a binder, a solid electrolyte, and the like.

The positive electrode tab 25 is connected to the positive electrode current collector 21. Examples of the material for the positive electrode tab 25 include aluminum, an aluminum alloy, stainless steel, nickel, iron, and titanium.

The negative electrode layer 30 includes a negative electrode current collector 31 and negative electrode active material layers 32 disposed on both side surfaces of the negative electrode current collector 31.

Examples of the shape of the negative electrode current collector 31 include a foil shape, a plate shape, a mesh shape, a nonwoven fabric shape, and a foamed shape. Examples of the material for the negative electrode current collector 31 include copper, a copper alloy, stainless steel, and nickel.

The negative electrode active material layer 32 may be any material as long as it contains a negative electrode active material capable of absorbing lithium ions during charging and releasing lithium ions during discharging. As the negative electrode active material, lithium, a metal or an alloy forming a lithium alloy, a carbon material, a lithium transition metal oxide, a transition metal oxide, a metal sulfide, or a metal nitride can be used. Examples of the metal or alloy forming a lithium alloy include Mg, Zn, Al, In, Si, Ge, Sn, Ag, Au, Pt, Pd, Pb, Sb, Bi, and alloys containing these. Examples of the carbon material include graphite, soft carbon, and hard carbon. Examples of the lithium transition metal oxide include lithium titanate (Li₄Ti₅O₁₂). Examples of the transition metal oxide include TiO₂, Nb₂O₃, and WO₃. In the case where the negative electrode active material is lithium, or a metal or an alloy forming a lithium alloy, the negative electrode active material may be a thin film. In the case where the negative electrode active material is powder of a carbon material, a lithium transition metal oxide, a transition metal oxide, a metal sulfide, a metal nitride, or the like, the negative electrode active material layer 32 may further contain a conductivity aid, a binder, a solid electrolyte, and the like.

The negative electrode tab 35 is connected to the negative electrode current collector 31. Examples of the material for the negative electrode tab 35 include copper, a copper alloy, stainless steel, and nickel.

The solid electrolyte layer 40 contains a solid electrolyte. The solid electrolyte is not particularly limited as long as it is a dielectric having lithium ion conductivity. The solid electrolyte may have a dielectric constant in the range of 20 F/m or more and 100 F/m or less and a dielectric loss in the range of 0.210 or more and 0.728 or less, in the frequency range of 1 MHz or more and 100 MHz or less. As the solid electrolyte, for example, a sulfide solid electrolyte, an oxide solid electrolyte, a nitride solid electrolyte, a halide solid electrolyte, or the like can be used.

Examples of the sulfide solid electrolyte include Li₂S—P₂S₅ and Li₂S—P₂S₅—LiI. The sulfide solid electrolyte may have an argyrodite-type crystal structure.

Examples of the oxide solid electrolyte include a NASICON type oxide, a garnet type oxide, and a perovskite type oxide. Examples of the NASICON type oxide include oxides containing Li, Al, Ti, P, and O (e.g., Li_{1.5}Al_{0.5}Ti_{1.5} (PO₄)₃). Examples of the garnet type oxide include oxides containing Li, La, Zr, and O (e.g., Li₇La₃Zr₂O₁₂). Examples of the perovskite type oxide include oxides containing Li, La, Ti, and O (e.g., LiLaTiO₃).

As the material for the outer casing 50, a laminate film can be used. As the laminate film, a laminated film having a three-layer structure in which an inner resin layer, a metal layer, and an outer resin layer are laminated in this order from the inner side can be used. The outer resin layer may be, for example, a polyamide (nylon) layer or a polyethylene terephthalate (PET) layer, the metal layer may be, for example, an aluminum layer, and the inner resin layer may be, for example, a polyethylene layer or a polypropylene layer.

The method for forming an all-solid-state battery according to the present embodiment includes a temperature raising step of raising the temperature of the all-solid-state battery 1 and an aging step of holding the all-solid-state battery 1 in which the temperature has been raised. The temperature of the all-solid-state battery 1 after raising the temperature varies depending on the structure and use of the all-solid-state battery 1, and is, for example, in the range of 40° C. or higher and 80° C. or lower.

In the method for forming an all-solid-state battery according to the present embodiment, an initial charge and discharge step of charging the all-solid-state battery 1 may be performed before the temperature raising step. The SOC (state of charge) of the all-solid-state battery 1 in which the temperature raising step is performed may be in the range of 50% or more and 100% or less.

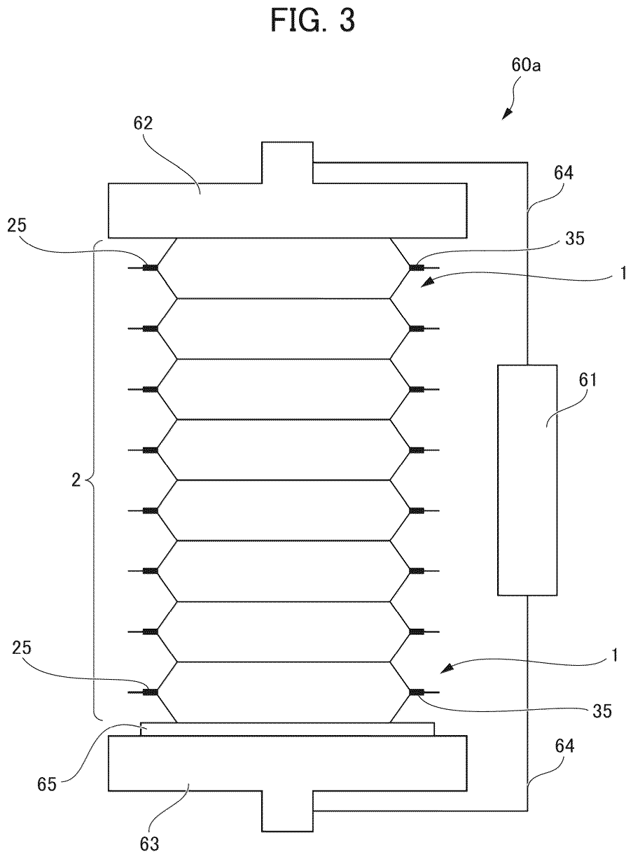

FIG. 3 is a schematic view showing an example of a dielectric heating system used in the temperature raising step of the method for forming an all-solid-state battery according to the present invention.

As shown in FIG. 3, a dielectric heating system 60a includes a high-frequency generator 61, a pair of electrodes including an application electrode 62 and a ground electrode 63, an electric wire 64, and a dielectric sheet 65 disposed on the ground electrode 63. The electric wire 64 connects the high-frequency generator 61 to the application electrode 62 and connects the high-frequency generator 61 to the ground electrode 63. An assembled battery 2 in which the all-solid-state batteries 1 are stacked along the stacking direction of the electrode stack 10 is disposed between the application electrode 62 and the dielectric sheet 65.

The high-frequency generator 61 generates a high-frequency AC electric field. The frequency of the high-frequency AC electric field may be, for example, 1 kHz or more, or may be in the range of 1 MHz or more and 200 MHz or less. The input power used to generate the high-frequency AC electric field may be in the range of 10 W or more and 400 W or less.

The application electrode 62 and the ground electrode 63 are disposed so as to sandwich the assembled battery 2. The application electrode 62 and the ground electrode 63 restrain the assembled battery 2 along the stacking direction of the electrode stack 10 in the all-solid-state battery 1. The application electrode 62 applies the high-frequency AC electric field generated by the high-frequency generator 61 to the assembled battery 2. The restraining pressure to the assembled battery 2 is, for example, in the range of 1.0 MPa or more and 5.0 MPa or less. As the materials for the application electrode 62 and the ground electrode 63, copper, a copper alloy, aluminum, or an aluminum alloy can be used.

The electric wire 64 may be any wire as long as it can electrically connect the high-frequency generator 61 to the application electrode 62 and electrically connect the high-frequency generator 61 to the ground electrode 63. As the material for the electric wire 64, copper, a copper alloy, aluminum, or an aluminum alloy can be used.

The dielectric sheet 65 prevents the ground electrode 63 from absorbing heat. As the dielectric sheet 65, a PTFE (polytetrafluoroethylene) sheet can be used

In the dielectric heating system 60a, the high-frequency AC electric field generated by the high-frequency generator 61 is applied to the assembled battery 2 via the application electrode 62. As a result, the high-frequency AC electric field is applied to each of the all-solid-state batteries 1 constituting the assembled battery 2. When the high-frequency AC electric field is applied to the all-solid-state battery 1, the solid electrolyte included in the solid electrolyte layer 40 of the electrode stack 10 of the all-solid-state battery 1 is dielectrically polarized. As a result, the molecules and atoms of the solid electrolyte vibrate in response to a change in the electric field, and thus, the solid electrolyte generates heat, and the solid electrolyte layer 40 acts as a heating element inside the all-solid-state battery 1. Since the all-solid-state battery 1 generates heat internally, even when the assembled battery 2 in which a plurality of all-solid-state batteries 1 are stacked is configured, the temperature of each of the all-solid-state batteries 1 can be uniformly raised, and the time required for the temperature rise can be shortened.

The input power (=current×voltage) used to generate the high-frequency AC electric field applied to the all-solid-state battery 1 is set within a range that does not damage the all-solid-state battery 1.

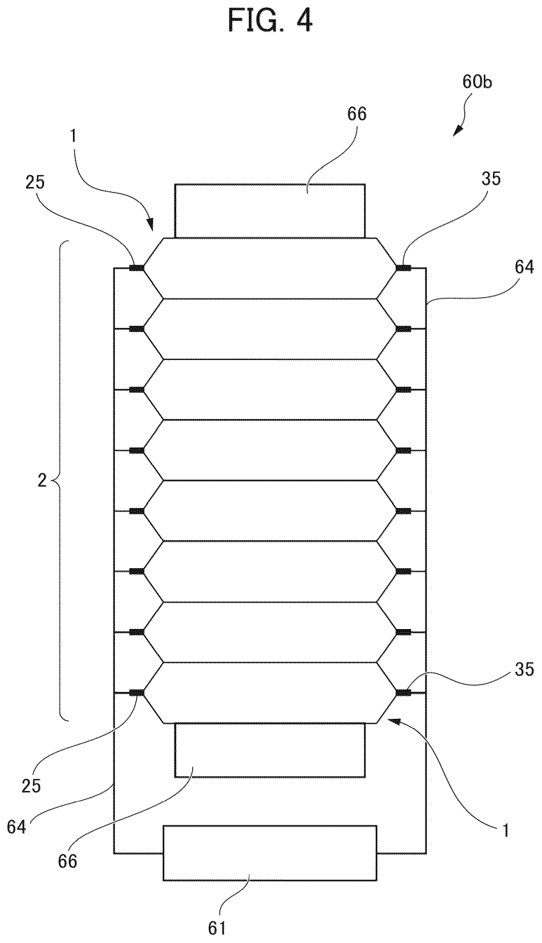

FIG. 4 is a schematic view showing another example of the dielectric heating system used in the temperature raising step of the method for forming an all-solid-state battery according to the present invention.

As shown in FIG. 4, a dielectric heating system 60b includes a high-frequency generator 61, an electric wire 64, and a restraining member 66. The electric wire 64 connects the positive electrode tab 25 and the negative electrode tab 35 of each of the all-solid-state batteries 1 constituting the assembled battery 2 to the high-frequency generator 61. The dielectric heating system 60b is the same as the dielectric heating system 60a described above except that the high-frequency generator 61 and the positive electrode tab 25 and the negative electrode tab 35 of each of the all-solid-state batteries 1 are connected by using the electric wire 64, instead of the application electrode 62 and the ground electrode 63, and the assembled battery 2 is restrained by the restraining member 66, and therefore, the same components are denoted by the same reference numerals and detailed descriptions thereof are omitted.

The restraining member 66 is disposed so as to sandwich the assembled battery 2. The restraining member 66 restrains the assembled battery 2 along the stacking direction of the electrode stack 10 in the all-solid-state battery 1.

In the dielectric heating system 60b, the high-frequency AC electric field generated by the high-frequency generator 61 is applied to the positive electrode current collector 21 and the negative electrode current collector 31 via the positive electrode tab 25 and the negative electrode tab 35 of each of the all-solid-state batteries 1 constituting the assembled battery 2. When the high-frequency AC electric field is applied between the positive electrode current collector 21 and the negative electrode current collector 31 of the all-solid-state battery 1, the solid electrolyte included in the solid electrolyte layer 40 is dielectrically polarized, and the solid electrolyte layer 40 generates heat. Since the all-solid-state battery 1 generates heat internally, the temperature of each of the all-solid-state batteries 1 can be uniformly raised, and the time required for raising the temperature can be shortened, as in the case of the dielectric heating system 60a.

In the aging step, the all-solid-state battery 1 whose temperature has been raised in the temperature raising step is held. The aging step can be performed using, for example, a thermostatic chamber. The aging step may be performed while the all-solid-state battery 1 is restrained in the stacking direction of the electrode stack.

The all-solid-state battery 1 after the aging step may be discharged and the SOC of the all-solid-state battery 1 after the aging step may be measured. The degree of deterioration of the all-solid-state battery 1 can be confirmed from the ratio of the Soc of the all-solid-state battery 1 after the aging step to the SOC of the all-solid-state battery 1 before the temperature raising step. The all-solid-state battery 1 having a large degree of deterioration is determined to be a defective product.

According to the method for forming an all-solid-state battery of the present embodiment configured as described above, since the above-described method is used as the method of raising the temperature of the all-solid-state battery in the temperature raising step, the temperature of the all-solid-state battery 1 can be raised from the internal solid electrolyte layer 40. Therefore, the time for uniformly raising the temperature of the all-solid-state battery can be shortened. In addition, since the temperature of the all-solid-state battery 1 can be uniformly raised without excessively raising the external temperature, the performance of the all-solid-state battery 1 is less likely to deteriorate. By shortening the time of the temperature raising step, the formation time of the all-solid-state battery 1 can be shortened, and the productivity of the all-solid-state battery 1 is improved.

In the method for forming an all-solid-state battery according to the present embodiment, when the frequency of the high-frequency AC electric field applied to the all-solid-state battery 1 in the temperature raising step is within the above range, the solid electrolyte layer 40 can be more reliably heated. Further, by setting the frequency of the high-frequency AC electric field based on the relative permittivity of the solid electrolyte layer 40, the solid electrolyte layer can be even more reliably heated.

According to the method for forming an all-solid-state battery of the present embodiment, the temperature of the all-solid-state battery 1 can be more uniformly raised by performing the temperature raising step while restraining the all-solid-state battery 1 in the stacking direction of the electrode stack 10.

In the method for forming an all-solid-state battery according to the present embodiment, when the dielectric heating system 60a or 60b is used in the temperature raising step, the temperature of each of the all-solid-state batteries 1 can be raised uniformly in the state of the assembled battery 2 in which a plurality of all-solid-state batteries 1 are stacked in the stacking direction of the electrode stack.

In the method for forming an all-solid-state battery according to the present embodiment, when the solid electrolyte layer 40 of the all-solid-state battery 1 contains a sulfide solid electrolyte, the solid electrolyte layer can be reliably heated by applying a high-frequency AC electric field.

### Verification Experiments

The effect of dielectric heating will be explained by the results of verification experiments.

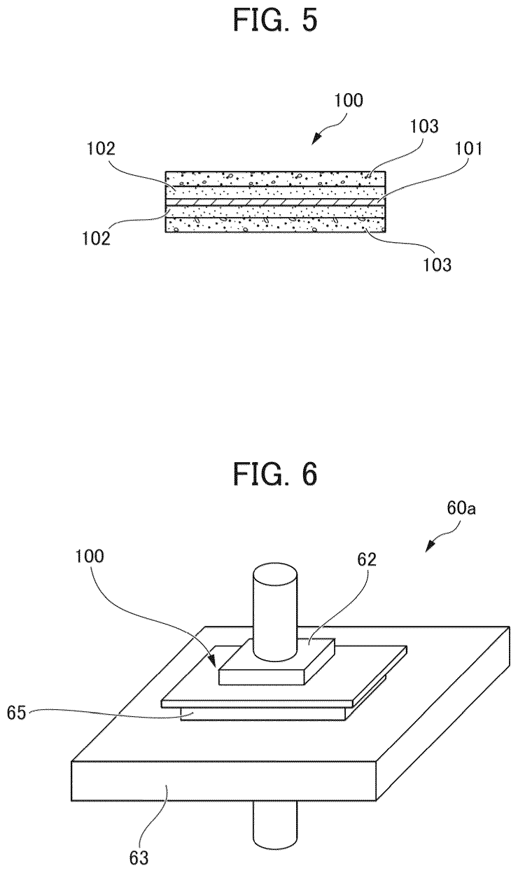

FIG. 5 is a cross-sectional view of an evaluation sample used in a verification experiment. An evaluation sample 100 is a stack including an aluminum foil 101 (100 mm×120 mm, thickness: 12 μm), solid electrolyte layers 102 (thickness: 75 μm) disposed on both surfaces of the aluminum foil 101, and positive electrode active material layers 103 (thickness: 75 μm) disposed on the sides of the solid electrolyte layers 102 opposite to the aluminum foil 101 side.

The evaluation sample 100 was prepared by applying solid electrolyte slurry to both surfaces of the aluminum foil 101 and drying the slurry to form the solid electrolyte layers 102, and then applying positive electrode active material slurry to the surfaces of the solid electrolyte layers 102 and drying the slurry to form the positive electrode active material layers 103. The solid electrolyte slurry was prepared by mixing 97 parts by mass of an argyrodite-type sulfide solid electrolyte (median diameter: 3.0 μm) and 3 parts by mass of a SBR (styrene butadiene rubber)-based binder, pouring the resulting mixture into a solvent, and stirring and mixing the mixture. The positive electrode active material slurry was prepared by mixing 80 parts by mass of a lithium nickel cobalt manganese composite oxide (NCM622), 17 parts by mass of an argyrodite-type sulfide solid electrolyte, 2 parts by mass of carbon black, and 1 part by mass of a SBR (styrene butadiene rubber)-based binder, and introducing the resulting mixture into butyl butyrate, followed by stirring and mixing.

In the verification experiments, the dielectric heating system 60a shown in FIG. 3 was used. First, a PTFE sheet (thickness: 1 mm) was disposed as the dielectric sheet 65 on the ground electrode 63. Next, the evaluation sample 100 was disposed on the dielectric sheet 65, and the application electrode 62 was disposed on the evaluation sample 100. The electrode size of the application electrode 62 was set to 20×30 mm. Then, a high-frequency AC electric field having a frequency of 40 MHz was applied to the evaluation sample 100 under the conditions shown in Table 1 below while pressing the evaluation sample 100 with a press load of 0.31 MPa in the stacking direction. The temperature of the evaluation sample 100 was measured using a thermal camera. The results are shown in Table 1. The verification experiments were performed in an environment at a temperature of 25° C.

TABLE 1

| Conditions for | | | Maximum Temperature | | |
|---|---|---|---|---|---|
| Dielectric Heating | | | of Evaluation Sample | | |
| Input | | Amount of | Before | After | Temperature |
| Power | Time | Electricity | Heating | Heating | Difference |
| (W) | (Second) | (KJ) | (° C.) | (° C.) | (° C.) |
| 20 | 60 | 1.2 | 25 | 42.1 | 17.1 |
| 40 | 30 | 1.2 | 25 | 51.7 | 26.7 |
| 60 | 20 | 1.2 | 25 | 58.6 | 33.6 |
| 80 | 10 | 0.8 | 25 | 59.5 | 34.5 |

From the results of Table 1, it was verified that dielectric heating enables the solid electrolyte layer to generate heat, and that the rate of heat generation by dielectric heating can be adjusted by the input power.

### EXPLANATION OF REFERENCE NUMERALS

1 all-solid-state battery
2 assembled battery
10 electrode stack
20 positive electrode layer
21 positive electrode current collector
22 positive electrode active material layer
25 positive electrode tab
30 negative electrode layer
31 negative electrode current collector
32 negative electrode active material layer
35 negative electrode tab
40 solid electrolyte layer
50 laminate film
60a, 60b dielectric heating system
61 high-frequency generator
62 application electrode
63 ground electrode
64 electric wire
65 dielectric sheet
66 restraining member
100 evaluation sample
101 aluminum foil
102 solid electrolyte layer
103 positive electrode active material layer

What is claimed is:

1. A method for forming an all-solid-state battery comprising an electrode stack in which a positive electrode layer, a negative electrode layer, and a solid electrolyte layer disposed between the positive electrode layer and the negative electrode layer are stacked, the method comprising:
a temperature raising step of raising a temperature of the all-solid-state battery by dielectrically heating the solid electrolyte layer by applying a high-frequency AC electric field along a stacking direction of the electrode stack; and
an aging step of holding the all-solid-state battery whose temperature has been raised.

2. The method for forming an all-solid-state battery according to claim 1, wherein a frequency of the high-frequency AC electric field is in a range of 1 MHz or more and 200 MHz or less.

3. The method for forming an all-solid-state battery according to claim 1, wherein a frequency of the high-frequency AC electric field is set based on a relative permittivity of the solid electrolyte layer.

4. The method for forming an all-solid-state battery according to claim 1, wherein the temperature raising step is performed while the all-solid-state battery is restrained in the stacking direction of the electrode stack.

5. The method for forming an all-solid-state battery according to claim 1, wherein the all-solid-state battery comprises a laminate film covering the electrode stack, a pair of electrodes are disposed on a surface of the laminate film so as to sandwich the all-solid-state battery in the stacking direction of the electrode stack, and the high-frequency AC electric field is applied between the pair of electrodes.

6. The method for forming an all-solid-state battery according to claim 1, wherein the all-solid-state battery comprises a laminate film covering the electrode stack, the positive electrode layer comprises a positive electrode current collector, a positive electrode tab connected to the positive electrode current collector is exposed from the laminate film, the negative electrode layer comprises a negative electrode current collector, a negative electrode tab connected to the negative electrode current collector is exposed from the laminate film, and the high-frequency AC electric field is applied between the positive electrode tab and the negative electrode tab.

7. The method for forming an all-solid-state battery according to claim 1, wherein the solid electrolyte layer comprises a sulfide solid electrolyte.
